(19) United States
(12) Patent Application Publication
(10) Pub. No.: US 2006/0015399 A1
(43) Pub. Date: Jan. 19, 2006

(54) Content distribution revenue sharing methods and devices therefore

(76) Inventors: William P. Alberth JR., Crystal Lake, IL (US); Scott A. Steele, San Diego, CA (US)

Correspondence Address: MOTOROLA INC, 600 NORTH US HIGHWAY 45, ROOM AS437, LIBERTYVILLE, IL, 60048-5343, US

(21) Appl. No.: 10/890,435

(22) Filed: Jul. 13, 2004

(51) Int. Cl. G06Q 30/00

(52) U.S. Cl. 705/14

(57) ABSTRACT

A method for distributing content (120) from a subscriber terminal (110) in a wireless communication system and sharing revenue between the subscriber and the service provider (130) by generating, at the subscriber terminal, a content available notification message (125). The content available notification message is associated with the content to be broadcast by the service provider. The subscriber terminal sends (230) the content available message and the content (120) to the service provider. The subscriber terminal receives consideration for the content which is sent to other subscribers from the service provider.

### FIELD OF THE DISCLOSURE

The present disclosure relates generally to the management of content, and more particularly to the distribution of content and the sharing of the revenue generated therefrom, for example, in short message service (SMS) EMS, MMS and broadcast enabled mobile cellular communications handsets, and methods therefor.

### BACKGROUND

The distribution of content from wireless devices promises new business opportunities for network operators and device users. The incorporation of multimedia devices such as cameras and audio players into radiotelephone handsets presents an opportunity for an intuitive electronic mechanism allowing consumers to exchange multimedia content with other consumers. This provides revenue generating opportunities for service providers as these files are generally larger data files, for which the service provider can charge for the exchange of the data from one user to another.

The mobile wireless communications industry has recognized that Digital Rights Management (DRM) technology may enable the secure exchange or distribution of content to, and controlled consumption thereof, on wireless communications devices. The Open Mobile Alliance (OMA), which is a wireless communications industry standardization body, has for example, developed DRM standards that generally provide the mechanisms required to package content and deliver content to the consumer. The OMA standards also provide for the assignment of permissions and constraints (“rights object”) to content, and the delivery of content and associated rights object to DRM enabled wireless communications terminals. The OMA DRM solution is independent of the transport and content delivery mechanism and is suitable for push and pull/download applications, Multimedia Messaging Services (MMSs), streaming applications, etc. These standards do not however provide for the exchange or distribution of individual user generated content to other users.

Individual users may distribute personally generated content by publishing the information on a website; however there is no mechanism to allow for revenue sharing between the service provider making the web page accessible on the internet and the originator of the content.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary content distribution diagram in a communications network.

FIG. 2 is an exemplary process flow block diagram.

### DETAILED DESCRIPTION

A method and apparatus for the sharing of revenue generated by content distribution is disclosed. The method comprises sending content from an originating subscriber terminal to a broadcast node, such as a service provider for example. The content is broadcast to other subscriber terminals in the broadcast area. In return for the content, the originating subscriber terminal receives consideration for the broadcast of the content by the broadcast node. The revenue generated from the broadcast of the content is shared between the broadcast node and the originating subscriber terminal.

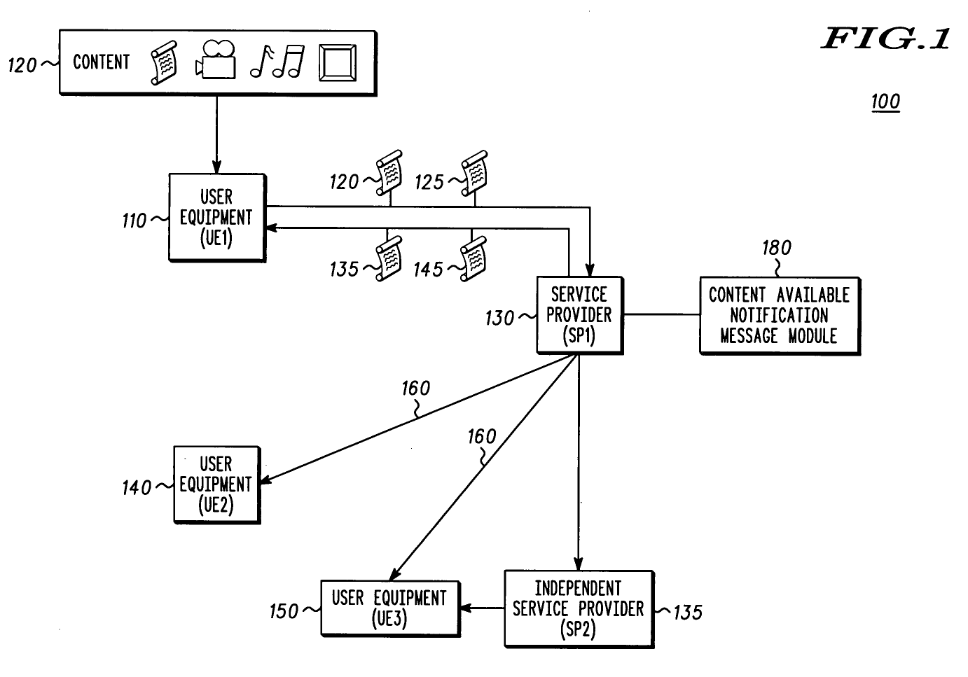

In the exemplary process diagram 100 of FIG. 1, a first subscriber terminal 110 obtains or generates content. In the exemplary application, the subscriber terminal is a mobile wireless communications device, for example, Code Division Multiple Access (CDMA) user equipment with 1× Evolution Data optimized (1× EV DO) capability, Global System for Mobile communications (GSM) user equipment (UE) that communicates in a GSM communications network, or Universal Mobile Telephony Standards (UMTS) W-CDMA UE that communicates in a UMTS communications network. The subscriber terminal or device may also communicate pursuant to some other communications standard. In other embodiments, the subscriber terminal may be a fixed terminal, for example, a personal computer or other device connected to the Internet or to some other network. The subscriber terminal may also be a DRM enabled home entertainment system that can perform DRM transactions for on-demand audio, video, gaming, etc. More generally, the subscriber terminal is any communications device with the capacity to receive and transmit or forward content, for example, over a network or directly to another device. There is no requirement that the communications device subscribe to any type of communications service, or that the device have the ability to use content, other than receive and transmit content.

In FIG. 1, the exemplary subscriber terminal UE1 110 generates content 120 such a picture, video, graphics, data or the like. In this embodiment, the subscriber terminal that sends the content 120 is the originating subscriber terminal, subscriber terminal UE1 110 for example and the content, for the subsequent broadcast at least, originates at this terminal. Mechanisms and protocols for generating or capturing content 120 in communications subscriber terminals are well known. Transferring and exchanging the data within the communications networks is also well known.

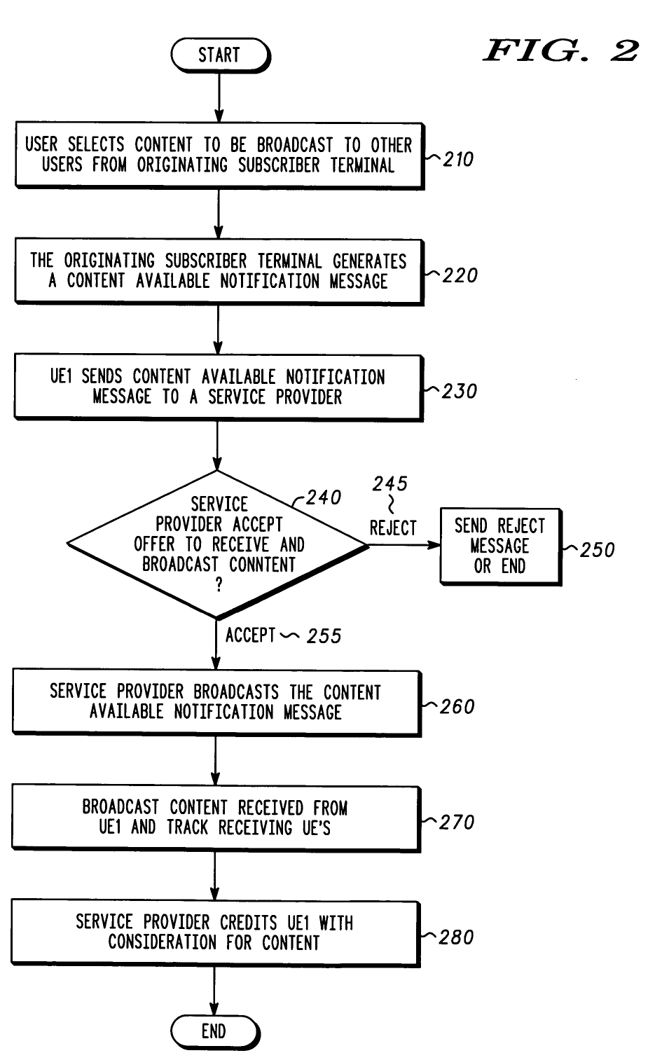

In the process diagram 200 of FIG. 2, at block 210, a user selects content at the originating subscriber terminal UE1 110, desired to be broadcast to other users. In FIG. 1, the user generates or selects the content 120 using a user interface carried on the subscriber terminal UE1 110. For example, the user of subscriber terminal UE1 110 uses a user interface of the subscriber terminal UE1 110 to generate content 120 such as a picture taken with a camera carried on the subscriber terminal UE1 110. The user then uses a user interface on the subscriber terminal UE1 to select for broadcast to other users the content (i.e. the picture). As part of the exemplary process, when the user selects the content 120, the subscriber terminal UE1 110 generates, at block 220, a content available notification message 125 that is associated with or describes the content 120. The subscriber terminal sends, at block 230, the content available notification message 125 to a broadcast node 130.

The broadcast node 130 may be a service provider 130 that provides cellular service to radiotelephones such as a CDMA 1× EV DO system, a wide area wireless broadcast system such as WiMax (802.16) or systems that operate over a smaller area such as WiFi (802.11). The service provider 130 may be capable of broadcasting the content 120 received from the subscriber terminal UE1 110 or service provider 130 may be capable of providing the content 120 to an independent broadcast node 135 capable of broadcasting the content 120 to other subscriber terminals, such as the WiFi local area network system. In the following embodiments the service provider 130 is used as the exemplary broadcast node 130. The service provider 130 may be associated with the subscriber terminal UE1 110 providing service thereto or the service provider 130 may be independent from the subscriber terminal UE1 110 service provider 130 providing service to other subscriber terminals.

The content available notification message 125 in this one exemplary embodiment is a short message service message (SMS). In other exemplary embodiments, the content available notification message 125 may be an enhanced message service message (EMS), a multimedia message service message (MMS), an email message, data message or the like. It is understood that the message may be a stand alone message that only has the purpose of notifying a broadcast node that content is available from the originating subscriber terminal UE1 110. The content available notification message 125 may be an advertisement regarding the content 120 or an offer from the user to the service provider 130. The service provider 130 determines, at block 240, if it will accept or reject the offer to broadcast the content 120 received from the subscriber terminal UE1 110 based on the content available notification message 125 received.

The content available notification message 125 message may contain information notifying the recipient about the content 120 (i.e. without any content included therein) or the content available notification message 125 may carry both the content available notification message 125 and the content 120. For example, an MMS message may include the content available notification message 125 as well as the content 120 such as text, voice, or pictures (i.e. JPEG, GIF, PICT or the like) all in one message. In this exemplary embodiment, the content 120 and the content available notification message 125 are one entity. Other message types may carry either the content available notification message 125 or the content 120 or both and the MMS message is used for exemplary purposes.

In FIGS. 1 and 2, if the service provider 130 rejects (step 245) the offer to broadcast the content 120 it may send a reject message 135 back to the subscriber terminal UE1 110 or may do nothing and the process ends at block 250. In one exemplary embodiment, where a reject message 135 is not sent, the subscriber terminal UE1 110 may have a timer that starts when the content available notification message 125 has been sent to the service provider 130. If an accept message is not received from the service provider 130 and the timer reaches a predetermined time limit the subscriber terminal UE1 110 will assume the message has been rejected.

Upon acceptance (step 255) of the offer to broadcast the content 120, the service provider 130, in this exemplary embodiment of the process, broadcasts (step 260) the content available notification message 125 over a predetermined broadcast area. Other subscriber terminals within the broadcast area, such as the exemplary subscriber terminal UE2 140 and UE3 150 may receive the broadcast of the content available notification message 125 and determine whether to accept or reject (step 240) reception of the content associated with the content available notification message 125.

The service provider 130 receives the content 120 from the originating subscriber terminal UE1 110 and broadcasts (step 260) the content 120 to the subscriber terminals that have accepted to receive the content 120. Mechanisms and processes for transferring content over wires and wirelessly are well known in the art. If none of the subscriber terminals (i.e. UE2 and UE3 in the exemplary embodiment) accept reception of the content 120, the content need not be transmitted by the service provider 130 to conserve bandwidth. The service provider 130 tracks, at bock 270, which subscriber terminals in the broadcast area accepted to receive the content 120 and the service provider 130 determines the total number of subscriber terminals that are to receive the content 120 from the originating subscriber terminal UE1 110. The service provider 130, in exchange for the content 120 gives consideration, at block 280, to the originating subscriber terminal UE1 110. Consideration may be in a plurality of forms and schemes. For example, the amount of consideration may be a flat fee or may be based on the number of other subscriber terminals that choose to receive the content 120. Both the service provider 130 and the originating subscriber terminal UE1 110 share the revenue generated from the distribution of the content 120.

The revenue share allotment that the originating subscriber receives from the service provider 130 may be negotiated therebetween or may be based upon a fixed rate or rate schedule. The amount of compensation provided to the originating subscriber may for example be based on the amount or type of content provided or the length of time that subscriber terminals receive the content 120 or the number or subscriber terminals that receive the content 120. For example, if the content is a one minute movie, the originating subscriber terminal UE1 110 would receive a first compensation value and if the content is a ten minute movie, the originating subscriber terminal UE1 110 would receive a second compensation value. In another example, if the one minute movie is received by 100 other subscriber terminals, the originating subscriber may receive compensation for each of the 100 subscriber terminals receiving the content 120. In yet another example, the amount of compensation that the originating subscriber terminal UE1 110 receives is based on the number of data bits transferred.

The consideration may be collected and accounted for at the service provider 130 or may be collected and accounted for at the originating subscriber terminal UE1 110. Mechanisms for accounts that track time or data bits transferred are well known in the art. The service provider 130, will account for the type of information or amount of data transferred and provide for the information on a billing statement associated with the originating subscriber terminal UE1 110. For example, the service provider, through billing software or system may track the data bits transferred when broadcasting content 120 and based on the amount of data transferred and the number of subscriber terminals 140, 150 receiving the content 120 broadcast, give consideration in the form of monetary credit to the subscriber of the originating subscriber terminal UE1 110 or the account associated therewith. The subscriber terminal UE1 110, or account associated therewith receives the consideration for the content broadcast from the broadcast node. Other consideration may be given and monetary credit is given as exemplary consideration. For example, prizes, points, airtime and the like may be awarded in return for the broadcast of the content 120. The consideration is a portion of the revenue generated as a result of the broadcast node broadcasting the content. As one of ordinary skill in the art will appreciate, there are numerous ways to apply consideration to the subscriber and are not limited to the examples given in this disclosure.

The content 120 may be already stored on the subscriber terminal UE1 110, in a memory carried on the device or removably coupled to the device such as removable media (e.g. compact flash, secure digital, USB drive or the like) or content 120 that will be streamed real time from the subscriber terminal UE1 110. It should be noted that content that is streamed may still be stored in a memory of the device but may only be temporary as transmission may not be instantaneous. Content 120 that is stored on the device, such as a photograph or video, may be selected by the user to send or for streaming at a later time. Once the content 120 is selected the content available notification message 125 is sent to the service provider 130 as with any of the methods discussed above. The content available notification message 125 may be sent automatically by the device or the user may manually initiate the transmission of the content available notification message 125. Once the offer is accepted (step 255) by the service provider 130, the subscriber terminal UE1 110 sends the content to the service provider 130.

In one exemplary embodiment the step of selecting the content 120 for broadcast comprises selecting a user interface coupled to the device and then generating content 120 with the user interface. The content 120 is either stored for sending at a later time or streamed at substantially the same time as the content is sent to the service provider 130.

When the content 120 has not previously been captured or stored on the subscriber terminal UE1 110 but is instead to be streamed from or broadcast live from the subscriber terminal UE1 110, the user can select the type of content or the user interface such as an input device on the subscriber terminal UE1 110 that will capture or generate the content 120. Selecting the content to be streamed comprises selecting the input device of the subscriber device that will capture or generate the content to be streamed. The input device may be a camera, a microphone, a touch screen display, other sensors or the like. A camera may capture still photographs or images or video files such as MPEG files or the like.

Once a broadcast session for streaming the content 120 has been established, the subscriber terminal UE1 110 will send a content available notification message 125 when the subscriber terminal is either ready to stream the content 120 or include information as to when the content 120 will be streamed. In the latter exemplary embodiment the content available notification message 125 will include the time at which the content 120 will be sent and may include the duration along with other information from the subscriber terminal UE1 110 prior to the streaming of the content 120.

In one embodiment, the content available notification message 125 is an SMS message. The SMS message includes a broadcast identifier that indicates to the service provider 130 that the SMS is a content available notification message 125. When the service provider 130 receives (step 230) the content available notification message 125, the SMS message in this exemplary embodiment, the broadcast identifier is recognized by the service provider 130 and the content available notification message sent to a content available notification message module 180. The content available notification message module 180 may be a software routine within the SMS message handling system or a separate module coupled to the core network. The content available notification message module determines, in block 240, whether to accept or reject the offer to broadcast the content 120.

In one exemplary embodiment, the broadcast identifier is in the subject field of the SMS message. The broadcast identifier may be anywhere in the SMS message as long as the service provider 130 can read or recognize the broadcast identifier. It is understood by one of ordinary skill in the art that EMS, MMS, or other messages may be used interchangeably as the content available notification message 125. For example the broadcast identifier may be placed in a subject field of an EMS message.

The process of accepting and rejecting the content for broadcast may be carried out by software algorithms in the content available notification message module 180, by manual operations, or a combination thereof. For manual acceptance and rejection decisions, an operator may view the content and make the determination. The operator may also make the determination of the amount of consideration to be allotted to the originating subscriber.

In one embodiment the content may be encrypted. The subscriber may encrypt the content 120 at the subscriber terminal UE1 110 or the service provider 130 may encrypt the content prior to broadcast. Encrypting the content may allow only users who have paid for or signed up for the service or particular content 120 to receive the content 120. The originating subscriber terminal UE1 110 may use digital rights management (DRM) software to control distribution and or track the distribution for licensing fee collection purposes. A rights object would be transferred to the subscriber terminal UE2 or UE3 receiving the content 120. The rights object would give rights to use the content 120. The rights object may be received from the service provider 130, the originating subscriber terminal UE1 110, or a third party such as a content provider or the like.

In this exemplary embodiment, the method further comprises, encrypting the content selected by the subscriber terminal. Then combining the encrypted content in a digital rights management package and transmitting the digital rights management package to the subscriber terminal from which the content available notification message 125 was received.

Users may accept or subscribe to individual content 120, specific classes of content (for example: content depicting accidents; content showing specific locations; content showing classic cars, content show a famous person), or content from a individual author (a user may subscribe to always accept content from a specific person who has previously generated content of interest to the user). Methods for subscribing to services are well known in the industry and can be easily adapted to provide the described subscription service.

In one exemplary embodiment a content distribution system comprises at least two subscribers, a first subscriber and a second subscriber. In this embodiment, the first subscriber has the second subscriber terminal UE2 140 and the second subscriber has the first subscriber terminal UE1 110. The system also includes a means to distribute content 120 which is generated by at least one of the at least two subscribers. The means to distribute the content 120 may be a service provider 130, another subscriber terminal, or any terminal capable of broadcasting the content generated by the subscriber terminal UE1 110. The first subscriber chooses to subscribe to the content 120 generated by the second subscriber. The first subscriber may choose to subscribe to content containing a topic of interest thereto as discussed above or the topic of interest may be a specific class or an individual person or author or a plurality of people. In one exemplary embodiment the topic of interest may be content depicting a specific location or a plurality of locations.

While the present disclosure and what are considered presently to be the best modes of the inventions have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a wireless communication device for revenue sharing, the method comprising:
sending content for broadcast from an originating subscriber terminal to a broadcast node; and
receiving consideration for the broadcast of the content by the broadcast node to a broadcast area.

2. The method of claim A1, receiving the consideration for the content broadcast from the broadcast node.

3. The method of claim A1, wherein the consideration is a portion of the revenue generated as a result of the broadcast node broadcasting the content.

4. The method of claim A1, wherein the broadcast node is a service provider.

5. The method of claim A1, generating at the originating subscriber terminal a content available notification message for broadcast by a broadcast node, wherein the content available notification message is associated with the content.

6. The method of claim 5, sending the content available message to the service provider.

7. The method of claim 1, prior to sending the content available notification message, selecting content to be sent to the service provider for broadcast.

8. The method of claim 1, prior to sending the content available notification message, selecting content to be streamed to the service provider for broadcast.

9. The method of claim 8, wherein the step of selecting the content to be streamed comprises selecting an input device of the subscriber device to capture the content to be streamed.

10. The method of claim 8, wherein the step of selecting the content for broadcast comprises:
selecting a user interface coupled to the device; and
generating content with the user interface.

11. The method of claim 10, wherein the input device is a camera, a microphone, a sensor, or a touch screen display.

12. The method of claim 1, wherein the content available notification message is an email, a SMS message an EMS message or a MMS message.

13. The method of claim 12, further comprising inserting a broadcast identification in a subject field of the email, SMS, EMS, or MMS.

14. The method of claim 12, further comprising inserting the content into the email, SMS message, EMS message or the MMS message.

15. The method of claim 7,
encrypting the content selected by the subscriber terminal,
combining the encrypted content in a digital rights management package,
transmitting the digital rights management package to the subscriber terminal from which the content available notification message was received.

16. A method in a communication system for sharing revenue comprising:
receiving content from an originating subscriber terminal;
broadcasting the content to a broadcast area having a plurality of subscriber terminals; and
providing consideration to the originating subscriber terminal for the content broadcast to the broadcast area.

17. A method in a wireless communication network comprising:
receiving a content available notification message from an originating subscriber terminal, wherein the content available notification message is associated with content stored therein;
determining a broadcast availability for the content;
receiving the content from the first device;
sending the content to a second device; and
crediting the originating subscriber terminal for the content.

18. A wireless communication device comprising:
a microprocessor;
a transmitter and a receiver both coupled to the microprocessor;
a content generation module coupled to the microprocessor;
a consideration reception and storage module coupled to the microprocessor.

19. A content distribution system comprising:
at least two subscribers, a first subscriber and a second subscriber;
a means to distribute content which is generated by at least one of the at least two subscribers; and
wherein the first subscriber chooses to subscribe to content generated by the at least two subscribers.

20. A content distribution system comprising;
a first subscriber and a second subscriber;
a means to distribute content which can be generated by at least one of the first subscriber or the second; and
wherein the first subscriber can choose to subscribe to content containing a topic of interest thereto.

21. The distribution system of claim 20, wherein the topic of interest may be specific or an individual person or a plurality of people.

22. The distribution system of claim 20, wherein the topic of interest may be content depicting a specific location or a plurality of locations.
